(19) United States
(12) Patent Application Publication
(10) Pub. No.: US 2010/0065173 A1
(43) Pub. Date: Mar. 18, 2010

(54) TIRE HAVING TREAD WITH AN INTERNAL CLOSED CELLULAR RUBBER TRANSITION LAYER

(75) Inventors: Ping Zhang, Hudson, OH (US); Paul Harry Sandstrom, Cuyahoga Falls, OH (US); Joseph Kevin Hubbell, Akron, OH (US); Robert Anthony Neubauer, Medina, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(73) Assignee: The Goodyear Tire & Rubber Company

(21) Appl. No.: 12/626,042

(22) Filed: Nov. 25, 2009

Related U.S. Application Data
(63) Continuation-in-part of application No. 11/857,578, filed on Sep. 19, 2007.

(51) Int. Cl. B60C 11/00

(52) U.S. Cl. 152/209.5

(57) ABSTRACT

The invention relates to a tire having a rubber tread configuration comprised of a circumferential non-cellular outer rubber cap rubber layer which contains a tread running surface, a circumferential internal, intermediate closed cellular rubber transition rubber layer positioned between said outer tread cap non-cellular rubber layer and a circumferential tread base non-cellular rubber layer. Said internal cellular rubber layer is thereby exclusive of said tread running surface and thereby abridges and joins said outer non-cellular rubber cap layer and said non-cellular base rubber layer of said tread configuration.

This continuation-in-part application claims priority from U.S. application Ser. No. 11/857,578, filed on Sep. 19, 2007, currently pending.

### FIELD OF THE INVENTION

The invention relates to a tire having a rubber tread configuration comprised of a circumferential non-cellular outer rubber cap rubber layer which contains a tread running surface, a circumferential internal, intermediate closed cellular rubber transition rubber layer positioned between said outer tread cap non-cellular rubber layer and a circumferential tread base non-cellular rubber layer. In one embodiment, the internal closed cellular rubber layer composition contains the product of a methylene donor and methylene acceptor to promote an enhanced dimensional stability and enhanced handling performance of tires. Said internal cellular rubber layer is exclusive of said tread running surface and abridges and joins said outer non-cellular rubber cap layer and said non-cellular base rubber layer of said tread configuration. The cellular rubber layer may contain an inclusion of short fibers such as, for example, polyaramid short fibers.

### BACKGROUND AND PRESENTATION OF THE INVENTION

Pneumatic rubber tires have treads which are typically configured with an outer rubber cap layer which contains a running surface for the tire and an underlying tread base rubber layer which interfaces with the tire carcass. The tire carcass may include a circumferential cord reinforced rubber belt layer.

The tread outer rubber cap layer is typically prepared with a relatively expensive combination of elastomers and compounding ingredients intended to promote a tire running surface with suitable resistance to tread wear, with good wet traction and with good (e.g. reduced) rolling resistance.

Accordingly, motivation is present for preparing a novel cost-savings tire tread with suitable physical attributes in a manner which is a departure from past practice.

For this invention, it is proposed to provide a significantly less expensive internal closed cell rubber transition rubber layer positioned between the outer non-cellular tread cap rubber layer and inner non-cellular tread base rubber layer. Said internal and intermediately positioned closed cell rubber transition layer is therefore non-ground contacting and is therefore exclusive of the running surface of said outer tread cap rubber layer, and, further, exclusive of the tread base rubber layer.

In practice, a major function of the tread cap layer is typically to promote traction for the tire tread at its running surface, promote resistance to tread wear and often to promote a reduction in rolling resistance for the tire.

The radially inner tread base rubber layer is typically composed of a softer and cooler running rubber composition, as compared to the rubber composition of the radially outer tread cap layer.

For this invention, the closed cellular internal intermediate transition rubber layer is presented as a significant departure from use of either a combination of circumferential outer non-cellular tread cap rubber layer and an underlying circumferential tread non-cellular base rubber layer or a combination of outer cellular tread cap layer and underlying non-cellular tread base layer.

In this manner, then, the internal closed cellular transition tread rubber layer positioned between a non-cellular tread outer rubber cap layer and non-cellular inner tread rubber base layer is considered herein to be neither of the outer tread cap rubber layer nor the tread base rubber layer and, further, serves a function for the tread different from the outer tread cap rubber layer and the inner tread base rubber layer.

This is considered herein to be significant in a sense that inclusion of the internal closed cellular transition rubber layer is to provide a beneficial reduction in tire weight and cost without adversely affecting the wet traction and treadwear properties of the running surface of the outer tread cap rubber layer.

In practice, the internal transition closed cellular intermediate rubber layer can further promote support for vehicle load through virtually millions of closed cellular gas-filled (e.g. nitrogen, carbon dioxide filled) bubbles contained in the rubber layer which may, in turn, promote an increased cushion effect and might provide a reduction of noise for vehicular ride comfort, depending somewhat upon variables such as, for example, the nature of the internal closed cellular rubber layer, the particular tire and the associated vehicular suspension system.

Heretofore, various dual layered tire treads have been proposed which are composed of a cap/base construction in which the outer tread cap rubber layer contains a running surface for the tire and the underlying tread base rubber layer provides, in a sense, a cushion for the tread cap layer, such as for example U.S. Pat. No. 6,959,743 or of a dual tread base layer configuration, such as for example U.S. Pat. No. 6,095,217 as well as a cap/base construction in which the base layer extends into lugs of the tread and into its tread cap layer such as for example U.S. Pat. No. 6,336,486.

Closed cellular rubber layers have been used for various components of a rubber tire as a puncture sealant layer. For example, see U.S. Pat. Nos. 4,163,467, 4,210,588, 4,249,588 and 4,210,187.

Further, various tread configurations have been suggested which contain a closed cellular rubber layer to promote, for example, enhanced ice traction, such as, for example U.S. Pat. Nos. 6,427,738, 6,336,487, 6,021,831, 5,753,365, 5,181,976, 5,147,477 and 4,249,588.

The tire tread of this invention differs significantly therefrom in at least one aspect in the sense that its transition rubber layer is intended to be exclusive of the outer tread cap rubber layer and the tread base rubber layer, if used.

The internal intermediate, transition closed cellular rubber layer may be formed, for example, by co-extrusion of the blowing agent-containing rubber layer together with the tread cap rubber layer and tread base rubber layer. The formation of the closed cellular internal rubber layer is formed by activation of the heat activatable (heat activatable in a sense of having an ability to decompose at an elevated temperature to release a gaseous product) during the curing of the tire assembly in a suitable tire cure mold at an elevated temperature with the release of a gas from a resultant decomposition of the blowing agent to form a closed cellular foam. The internal transition closed cellular foam rubber layer is thereby integral with both the outer tread rubber cap layer (on one side of the closed cellular rubber layer) and the tread base rubber layer (on the opposite side of the closed cellular rubber layer).

In the description of this invention, the terms “rubber” and “elastomer” where used herein, are used interchangeably, unless otherwise prescribed. The terms “rubber composition”, “compounded rubber” and “rubber compound”, where used herein, are used interchangeably to refer to “rubber which has been blended or mixed with various ingredients” and the term “compound” relates to a “rubber composition” unless otherwise indicated. Such terms are well known to those having skill in the rubber mixing or rubber compounding art.

In the description of this invention, the term “phr” refers to parts of a respective material per 100 parts by weight of rubber, or elastomer. The terms “cure” and “vulcanize” are used interchangeably unless otherwise indicated.

### SUMMARY AND PRACTICE OF THE INVENTION

In accordance with this invention, a tire is provided having a rubber tread comprised of a circumferential non-cellular tread outer cap layer, an internal circumferential intermediate transition closed cellular rubber layer positioned between said outer tread cap rubber layer and a tread base non-cellular rubber layer;

wherein said outer tread cap rubber layer is comprised of a lug and groove configuration with raised lugs having tread running surfaces on the outer surfaces of said lugs (said running surfaces intended to be ground-contacting) and grooves positioned between said lugs,

wherein said internal intermediate transition cellular rubber layer is excluded from the running surface of the tire, and

wherein said internal intermediate transition cellular rubber thereby abridges and joins said outer non-cellular rubber cap layer and said non-cellular base rubber layer of said tread configuration.

In practice, the said internal closed cellular rubber transition rubber layer is comprised of an in situ formed closed cellular structure which is formed during the curing of the tire assembly at an elevated temperature by activation of a heat activatable (elevated temperature activatable) blowing agent.

In practice, the rubber composition of the closed cellular transition rubber layer may contain conjugated diene-based elastomer(s), one or more reinforcing fillers such as for example, carbon black, synthetic amorphous silica such as, for example, precipitated silica, ultra high molecular weight polyethylene (UHMWPE), syndiotactic polybutadiene, short fibers including chopped fibers, as well as other ingredients commonly used in rubber compounds for tire applications.

In one embodiment, said closed cell transition layer rubber may be comprised of, based upon parts by weight per 100 parts by weight rubber (phr):

(A) 100 phr of at least one diene-based, preferably conjugated diene-based, elastomer;

(B) about 20 to about 120 phr of reinforcing filler comprised of:
(1) rubber reinforcing carbon black, or
(2) a combination of rubber reinforcing black and synthetic amorphous silica containing up to 100 phr, alternately from about 5 to about 100, phr of synthetic amorphous silica, preferably precipitated silica;

wherein said rubber layer may further contain one or more of ultra high molecular weight polyethylene (UHMWPE), syndiotactic polybutadiene, and short fibers to promote enhanced stiffness and dimensional stability of the closed cellular rubber composition.

In one embodiment of the invention, a process of preparing a tire is provided which comprises the steps of preparing a tire with a tread which contains an internal closed cellular rubber layer positioned between and abridging an outer non-cellular tread rubber layer having a tread running surface and a non-cellular tread base rubber layer which comprises the steps of:

(A) preparing an uncured rubber layer comprised of a rubber composition which contains an elevated temperature activatable blowing agent,

(B) building an uncured rubber tire assembly which includes a circumferential tread comprised of an outer uncured rubber layer without an elevated temperature activatable blowing agent and a circumferential internal uncured rubber layer which contains an elevated temperature activatable blowing agent wherein said internal uncured rubber layer is positioned between and abridges said outer uncured rubber layer and a circumferential uncured tread base rubber layer which does not contain an elevated temperature blowing agent,

(C) placing said uncured rubber tire assembly in a tire mold under conditions of elevated pressure and temperature to mold and cure the rubber tire assembly, including said tread,

wherein said elevated temperature activatable blowing agent is thereby activated to release a gaseous byproduct in situ within the rubber composition and form a closed cellular structure for said internal rubber layer within said tread during the curing of said internal rubber layer.

A significant aspect of the process is for the blowing agent to form the closed cellular structure for the internal rubber layer:

(A) in situ within the tread comprised of the internal rubber layer positioned between the uncured outer rubber layer and uncured base rubber layer, and

(B) during the curing of the internal rubber layer (and thereby during the curing of the tread containing the internal rubber layer).

In one embodiment of the process, said circumferential uncured rubber tread is prepared by co-extruding together said uncured internal rubber layer, outer uncured layer and uncured tread base rubber layer to from an uncured tread rubber strip.

In further accordance with this invention, the foam rubber composition optionally further contains the product of methylene donor and acceptor compounds in an amount of, for example, about 0.1 to about 10 phr of each or their combination.

Representative examples of methylene donor compounds are, for example, hexamethoxymethylmelamine (preferable), hexaethoxymethylmelamine, ethoxymethylpyridinium chloride, N,N′,N′-trimethylmelamine, N-methylmelamine and N′,N″-methylmelamine as well as hexamethylenetetramine. For example, see U.S. Pat. No. 5,886,074. Such methylene acceptor compounds are well known to those having skill in such art.

Representative examples of methylene acceptor compounds are, for example, phenolformaldehyde reactive resin, resorcinol, resorcinol monobenazoate, phenolic cashew nut oil resin and polyhydric phenoxy resin. For example, see U.S. Pat. Nos. 5,206,289 and 4,605,696. Such methylene acceptor compounds are well known to those skilled in such art.

A significant aspect of utilization of the product of said methylene donor and methylene acceptor compounds (formed in situ within the rubber composition by separate addition of the methylene donor and acceptor compounds) is to provide a closed cell foam intermediate layer within the tire tread which promotes stiffness and handling qualities for the overall tire tread itself as well as an associated weight reduction of the tire tread.

The blowing agents contemplated for the formation of the closed cellular rubber tread inner layer are those which liberate gases upon heating to an elevated temperature, such as, for example, elevated temperatures experienced during the curing of the tire in a suitable tire mold. Representative examples of such agents are those which liberate gases such as, for example, nitrogen and carbon dioxide and may be, for example, various nitro, sulfonyl and azo compounds. Usually agents which liberate nitrogen are preferred. Representative of various blowing agents are, for example, p,p′-oxybis(benzenesulfonyl hydrazide), dinitrosopentamethylene tetramine, N,N′-dimethyl-N,N′-ditnitrosophthalimide, azodicarbonamide, sulfonyl hydrazides such as for example, benzenesulfonyl hydrazide, toluenesulfonyl hydrazide and sulfonyl semicarbazides such as for example, p-toluene sulfonyl semicarbazide and p,p′-oxy-bis-(benzenesulfonyl semicarbazide).

Various rubber reinforcing carbon blacks might be used for the tread rubber compositions, depending upon whether they are intended for use in the tire tread cap rubber layer or tread base rubber layer, or said intermediate transition cellular rubber layer. Representative of various rubber reinforcing blacks which may be considered, as referred to by their ASTM designations are those such as for example, although not intended to be limiting, N110, N120, N121, N134, N220, N234, N330, N550 and N650. These and other additional rubber reinforcing carbon blacks may found, for example, in The Vanderbilt Rubber Handbook (1978), Page 417.

Representative of various diene-based elastomers for said tread cap rubber, said tread transition rubber layer and said tread base rubber layer may include, for example, styrene-butadiene copolymers (prepared, for example, by organic solvent solution polymerization or by aqueous emulsion polymerization), isoprene/butadiene copolymers, styrene/isoprene/butadiene terpolymers and tin coupled organic solution polymerization prepared styrene/butadiene copolymers, cis 1,4-polyisoprene (natural and synthetic, usually preferably natural) and cis 1,4-polybutadiene as well as trans 1,4-polybutadiene 3,4-polyisoprene and high vinyl polybutadiene rubber.

### BRIEF DESCRIPTION OF THE DRAWINGS

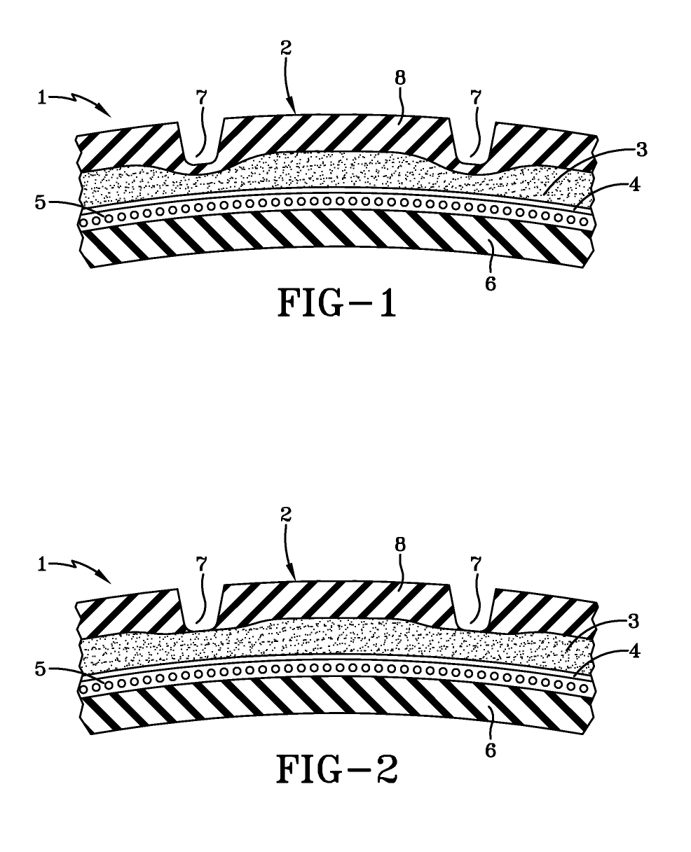

For a further understanding of this invention, FIG. 1 (FIG. 1) and FIG. 2 (FIG. 2) are provided as a partial cross-sectional view of a tire tread showing an internal, intermediate, non-ground contacting transition closed cellular foam layer within the tire tread configuration.

### THE DRAWINGS

FIG. 1 depicts a tread construction of a tread (1) having a circumferential non-cellular outer tread cap rubber layer (2) with grooves (7) and associated lugs (8), an internal closed cellular (closed cell containing) transition tread rubber layer (3) in a sense of replacing an internal portion of the tread cap rubber layer (2) positioned between said tread outer cap non-cellular rubber cap layer (2) and a circumferential non-cellular tread base rubber layer (4). FIG. 1 also depicts a circumferential belt ply, or plies, (5) for the tire carcass (6) underlying said tread (1), namely said tread base rubber layer (4) and overlaying the tire carcass (6). If desired, a nylon cord reinforced rubber layer (not shown) may also be positioned on top of the belt ply, or plies (5).

FIG. 2 represents the same tread construction as FIG. 1 except that the closed cellular transition rubber layer (3) occupies a significantly greater portion of the tread (1), particularly the non-cellular outer tread cap rubber layer (2), and extends to the bottom of at least a portion of the grooves (7), although in practice, a very thin rubber layer (not shown) of the tread cap rubber composition might, if desired, separate the closed cell transition layer (3) from the actual bottom of the grooves (7).

Accordingly, the circumferential closed cellular inner transition rubber layer (3) is shown as being an internal component of the tire tread itself in a sense of being positioned between and bridging two non-cellular circumferential rubber layers within the tire tread configuration, namely between said non-cellular tread cap rubber layer (2) and said non-cellular tread base rubber layer (4).

In practice, the rubber compositions may be prepared in at least one preparatory (non-productive) mixing step in an internal rubber mixer, often a sequential series of at least two separate and individual preparatory internal rubber mixing steps, or stages, in which the diene-based elastomer is first mixed with the prescribed silica and/or carbon black as the case may be followed by a final mixing step (productive mixing step) in an internal rubber mixer, or optionally on an open mill mixer, where curatives (sulfur and sulfur vulcanization accelerators), and the blowing agent for the rubber composition for said transition rubber layer, are blended at a lower temperature and for a substantially shorter period of time.

It is conventionally required after each internal rubber mixing step that the rubber mixture is actually removed from the rubber mixer and cooled to a temperature below 40° C., perhaps to a temperature in a range of about 20° C. to about 40° C. and then added back to an internal rubber mixer for the next sequential mixing step, or stage.

Such non-productive mixing, followed by productive mixing is well known by those having skill in such art.

The forming of a tire component is contemplated to be by conventional means such as, for example, by extrusion, or by calendering, of rubber composition to provide a shaped, unvulcanized rubber component such as, for example, a tire tread. Such forming of a tire tread is well known to those having skill in such art.

It is understood that the tire, as a manufactured article, is prepared by shaping and curing the assembly of its components at an elevated temperature (e.g. 140° C. to 170° C.) and elevated pressure in a suitable mold. Such practice is well known to those having skill in such art.

It is readily understood by those having skill in the pertinent art that the rubber composition would be compounded by methods generally known in the rubber compounding art, such as mixing the various sulfur-vulcanizable constituent rubbers with various commonly used additive materials, as herein before discussed, such as, for example, curing aids such as sulfur, activators, retarders and accelerators, processing additives, such as rubber processing oils, resins including tackifying resins, silicas, and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur vulcanized material (rubbers), the additives mentioned above are selected and commonly used in conventional amounts.

Typical amounts of fatty acids, if used, which can include stearic acid, comprise about 0.5 to about 3 phr. Typical amounts of zinc oxide comprise about 1 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur vulcanizing agent is elemental sulfur. As known to those skilled in the art, sulfur vulcanizing agents are used in an amount ranging from about 0.5 to about 4 phr, or even, in some circumstances, up to about 8 phr, with a range of from about 1.5 to about 2.5, sometimes from about 2 to about 2.5, being preferred.

Accelerators are used to control the time and/or temperature required for vulcanization and to improve the properties of the vulcanizate. In one embodiment, a single accelerator system may be used, i.e., primary accelerator. Conventionally and preferably, a primary accelerator(s) is used in total amounts ranging from about 0.5 to about 4, preferably about 0.8 to about 2.5, phr. In another embodiment, combinations of a primary and a secondary accelerator might be used with the secondary accelerator being used in smaller amounts (of about 0.05 to about 3 phr) in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The mixing of the rubber composition can preferably be accomplished by the aforesaid sequential mixing process. For example, the ingredients may be mixed in at least two stages, namely, at least one non-productive (preparatory) stage followed by a productive (final) mix stage. The final curatives are typically mixed in the final stage which is conventionally called the “productive” or “final” mix stage in which the mixing typically occurs at a temperature, or ultimate temperature, lower than the mix temperature(s) of the preceding non-productive mix stage(s). The terms “non-productive” and “productive” mix stages are well known to those having skill in the rubber mixing art.

### EXAMPLE I

Rubber compositions were prepared for evaluating an effect of providing an closed cellular rubber composition for an internal transition, intermediate layer for a tire tread to be positioned between a non-cellular outer tread cap rubber layer and a non-cellular tread base rubber layer.

Sample A is a Control rubber sample. Experimental rubber Samples B through G contained a heat activatable blowing agent.

The rubber compositions were prepared by mixing the ingredients in sequential non-productive (NP) and productive (PR) mixing steps in one or more internal rubber mixers.

The basic formulation for the rubber Samples is presented in the following Table 1 and recited in parts by weight unless otherwise indicated.

TABLE 1

| | Parts |
|---|---|
| Non-Productive Mixing Step (NP), (mixed to 160° C.) | |
| Emulsion prepared E-SBR rubber¹ | 70 |
| Cis 1,4-polybutadiene rubber² | 30 |
| Antioxidant³ | 1.5 |
| Carbon black (N120)⁴ | 90 |
| Processing oil and wax⁵ | 24 |
| Stearic acid⁶ | 2 |
| Zinc oxide | 2 |
| Productive Mixing Step (PR), (mixed to 110° C.) | |
| Sulfur and sulfur cure accelerators⁷ | 4.6 |
| Blowing agent, heat activatable⁸ | 3.75 |

¹Emulsion polymerization prepared styrene/butadiene rubber (E-SBR) 1712C ™ from The Goodyear Tire & Rubber Company
²Cis 1,4-polybutadiene rubber as BUD1207 ™ from The Goodyear Tire & Rubber Company
³Antoxidant of the diamine type
⁴Rubber reinforcing carbon black as N120, an ASTM designation
⁵Rubber processing oil and microcrystalline wax, primarily aromatic rubber processing oil
⁶Fatty acid comprised of at least 90 weight percent stearic acid and a minor amount of other fatty acid comprised primarily of palmitic and oleic acids.
⁷Sulfur cure accelerators of the sulfenamide and thiuram types
⁸Heat activatable (elevated temperature activatable) blowing agent comprised of p,p′- oxybis(benzenesulfonyl hydrazide) as Celogen OT ™ from the Crompton Corporation.

The following Table 2 illustrates cure behavior and various physical properties of rubber compositions based upon the basic formulation of Table 1.

TABLE 2

| | Samples | | | |
|---|---|---|---|---|
| Control | A | B | C | D |
| Blowing agent (phr) | 0 | 2.5 | 5 | 10 |
| Rheometer¹, 160° C. | | | | |
| Maximum torque (dNm) | 17 | 15.4 | 12.3 | 8.6 |
| Minimum torque (dNm) | 3.5 | 3.8 | 3.7 | 3.6 |
| Delta torque (dNm) | 13.5 | 11.6 | 8.6 | 5 |
| T90 (minutes) | 6.1 | 4.2 | 4.1 | 13 |
| Stress-strain, ATS², 14 min, | | | | |
| 160° C. | | | | |
| Tensile strength (MPa) | 16.2 | 16.9 | 14.9 | 8.8 |
| Elongation at break (%) | 604 | 657 | 714 | 674 |
| 300% modulus (MPa) | 6.5 | 6.2 | 4.7 | 3.3 |
| Rebound | | | | |
| 23° C. | 24.7 | 24.8 | 24.3 | 30.6 |
| 100° C. | 39.8 | 38.6 | 36.1 | 46.2 |
| Shore A Hardness | | | | |
| 23° C. | 74 | 74 | 72 | 54 |
| 100° C. | 59 | 59 | 56 | 39 |
| DIN Abrasion³, (10N) | | | | |
| Relative volume loss, cc | 119 | 120 | 112 | 215 |
| Compound density (g/cc) | 1.158 | 1.162 | 1.144 | 0.775 |

¹Moving Die Rheometer instrument, model MDR-2000 by Alpha Technologies, used for determining cure characteristics of elastomeric materials, such as for example torque, T90 etc.
²Automated Testing System instrument by the Instron Corporation which incorporates six tests in one system. Such instrument may determine ultimate tensile, ultimate elongation, modulii, etc. Data reported in the Table is generated by running the ring tensile test station which is an Instron 4201 load frame.
³DIN-53516

It can be seen from Table 2 that the density of the rubber composition (Compound density) is reduced when 5 and 10 phr of the blowing agent (Samples C and D) was introduced into the rubber composition and heat activated (elevated temperature activated) during the curing of the rubber composition at an elevated temperature.

This is considered herein to be significant in a sense that this Example demonstrates that the compound density can be controlled (e.g. reduced for Samples C and D) by the amount of the blowing agent added to the rubber composition.

### EXAMPLE II

A similar evaluation was conducted as in Example Ito determine if a closed cellular rubber can be prepared with improved rebound property, particularly for use as said internal closed cellular tread rubber layer. For this Example, the formulation was similar except that a methylene donor (in a form of hexamethoxymethylmelamine) and methylene acceptor (in a form of a phenolformaldehyde reactive resin) were added to the formulation as indicated in the following Table 3 for a product thereof to be formed in situ within the rubber composition. Rubber Sample E was a control Sample without the blowing agent and without the methylene donor and methylene acceptor compounds.

Rubber Samples F through K are experimental Samples which contain various amounts of the heat activatable blowing agent. Rubber Samples I through K also contained a combination of the methylene donor and methylene acceptor compounds.

The rubber Samples were prepared in the manner of the Sample preparation used in Example I.

TABLE 3

| | Parts |
|---|---|
| Non-Productive Mixing Step (NP), (mixed to 160° C.) | |
| Emulsion prepared E-SBR rubber¹ | 70 |
| Cis 1,4-polybutadiene rubber² | 30 |
| Antioxidant³ | 1.5 |
| Carbon black (N120)⁴ | 90 |
| Processing oil and wax⁵ | 24 |
| Stearic acid⁶ | 2 |
| Zinc oxide | 2 |
| Methylene acceptor⁹ | 0 and 3 |
| Productive Mixing Step (PR), (mixed to 110° C.) | |
| Sulfur and sulfur cure accelerators⁷ | 4.6 |
| Blowing agent, heat activatable⁸ | 0, 7, 8 and 9 |
| Methylene donor¹⁰ | 0 and 4 |

⁹Phenolformaldehyde reactive resin as SMD ™ 30207 from the SI Group
¹⁰Composite of hexamethoxymethylmelamine and silica carrier in a 28/72 weight ratio and thereby 72 percent active, reported in the above Table 3 as the composite.

The following Table 4 illustrates cure behavior and various physical properties of rubber compositions based upon the basic formulation of Table 3.

TABLE 4

| | Samples | | | | | | |
|---|---|---|---|---|---|---|---|
| | Control | | | | | | |
| | E | F | G | H | I | J | K |
| Blowing agent (phr) | 0 | 7 | 8 | 9 | 7 | 8 | 9 |
| Methylene donor (phr) | 0 | 0 | 0 | 0 | 4 | 4 | 4 |
| Methylene acceptor (phr) | 0 | 0 | 0 | 0 | 3 | 3 | 3 |
| Stress-strain, ATS, 14 min, 160° C. | | | | | | | |
| Tensile strength (MPa) | 16.9 | 10.7 | 7.9 | 4.8 | 11.3 | 8.9 | 7.8 |
| Elongation at break (%) | 570 | 677 | 645 | 536 | 728 | 659 | 638 |
| 300% modulus, ring (MPa) | 7.6 | 3.8 | 3.2 | 2.4 | 3.9 | 3.5 | 3.2 |
| Rebound | | | | | | | |
| 23° C. | 22.8 | 24.9 | 27.3 | 28.9 | 26.1 | 28.1 | 29.5 |
| 100° C. | 39.1 | 39.6 | 42.6 | 46.2 | 35.9 | 38.5 | 41.5 |
| Shore A Hardness, 23° C. | 72 | 66 | 61 | 55 | 68 | 63 | 57 |
| DIN Abrasion, Relative volume loss | 133 | 165 | 230 | 303 | 195 | 222 | 295 |
| Density (Specific gravity), (g/cc) | 1.158 | 0.955 | 0.842 | 0.725 | 0.914 | 0.82 | 0.737 |
| RPA (100° C.), Storage Modulus G′, MPa¹ | | | | | | | |
| Uncured G′ 15% strain | 0.202 | 0.209 | 0.209 | 0.209 | 0.215 | 0.221 | 0.218 |
| Cured G′ modulus, 10% strain | 1.421 | 1.097 | 1.021 | 0.969 | 1.427 | 1.372 | 1.309 |
| Blowout rubber failure test² | | | | | | | |
| Final temperature of the rubber, ° C. | 182 | 136 | 138 | 132 | 140 | 136 | 132 |
| Final test time, min, (60 min max) | 22 | 60 | 60 | 60 | 60 | 60 | 60 |
| Blowout failure within 60 minutes | Yes | No | No | No | No | No | No |

¹Rubber Process Analyzer as RPA 2000 ™ instrument by Alpha Technologies
²ASTM D623

From Table 4 it can be seen that the density of the rubber composition (rubber Samples I, J and K) was significantly reduced by the incorporation of (and subsequent heat activation of) from 7 through 9 phr of the blowing agent with the amount of reduction of the density being proportional to the amount of blowing agent used.

From Table 4 it can further be seen that the introduction of the methylene donor and methylene acceptor compounds into the blowing agent-containing rubber Samples I, J and K resulted in substantially maintained stiffness (G′ at 100° C. and a low 10 percent strain) and a blowing agent content, particularly for a level of 7 and 8 phr in rubber Samples I and J.

This is considered herein as being significant in a sense of indicating that a dimensional stability for the tire tread and resultant handling performance for a tire can be promoted.

It further demonstrates that the reduction in density of the rubber composition can be obtained in combination with substantially maintaining physical properties such as rebound and stiffness which thereby demonstrates that a weight reduction can be obtained while providing a closed cellular rubber composition that can be useful as the aforesaid tire tread internal, intermediate rubber layer positioned between a circumferential outer non-cellular tread outer tread cap layer and a circumferential non-cellular tread base rubber layer as a part of a tread configuration.

From Table 4 it can additionally be seen that the blowout performance of the rubber composition (Samples F through K) was improved with the addition of the combination of blowing agent and methylene donor and methylene acceptor compounds.

This is considered herein to be significant in a sense that the durability of the tire tread can thereby be promoted with the internal cellular rubber layer positioned between said outer non-cellular tread cap rubber layer and tread non-cellular rubber base rubber layer of a tread configuration and is a further demonstration that a tread weight reduction can be obtained by providing such closed cellular internal, transition rubber layer.

Although it is seen in Table 4 that the DIN abrasion value is adversely affected, this rubber composition is to be used internally within the tread configuration and not relied upon for a wear-resistant tire tread running surface.

### EXAMPLE III

Vehicular tires were prepared as a build-up assembly of uncured rubber components including a tread having layered configuration.

For a Control Tire (L), the uncured tread configuration comprised of an outer tread cap rubber layer (without a blowing agent) and an intermediate rubber layer (without a blowing agent) positioned between said outer tread cap rubber layer and a tread base rubber layer (also without a blowing agent).

For Control Tire (L), the outer tread cap rubber layer and internal intermediate rubber layer were comprised of a rubber composition containing reinforcing filler comprised of carbon black and a high level of precipitated silica together with a coupling agent for the precipitated silica and thereby referred to herein as being “silica reinforced”.

Two Experimental uncured rubber tires (M and N) were similarly prepared except that the internal, intermediate tread layer was provided as rubber compositions according to the formulations of Samples I and J, respectively of Example II, namely Sample I for Tire M and Sample J for Tire N and thereby contained reinforcement as carbon black and contained a elevated temperature activatable blowing agent.

The tire assemblies were individually placed in a suitable tire mold under conditions of elevated pressure and temperature to shape and cure the respective tires.

For Experimental Tires M and N the blowing agent contained in the internal transition rubber layer was caused by the elevated molding temperature to liberate its gas to form the closed cellular structure, or configuration, in situ within the internal rubber layer of the tire tread within the tire mold, and to therefore form a tire with a tread cross-section similar to FIG. 1 of the Drawings.

The following Table 5 reports observed results.

TABLE 5

| | Tire | | |
|---|---|---|---|
| | Control | | |
| | L | M | N |
| Outer, non-cellular tread | Silica/carbon black | Silica/carbon black | Silica/carbon black |
| cap layer | reinforced | reinforced | reinforced |
| Internal tread rubber layer | Non-cellular rubber | Cellular rubber | Cellular rubber |
| | carbon black | carbon black | carbon black |
| | reinforced | reinforced Sample I | reinforced Sample J |
| Tread base rubber layer | Natural rubber | Natural rubber | Natural rubber |
| | composition | composition | composition |
| Tire Weight (kg) | 11.2 | 10.88 | 10.84 |
| Tire Rolling Resistance (kg) | 4.80 | 4.67 | 4.74 |

From Table 5 it can be seen that the overall weights of the Experimental Tires M and N, which contained the internal intermediate closed cellular rubber, are significantly reduced as compared to the Control Tire L while maintaining similar rolling resistances.

This is considered herein as being significant in a sense that a weight reduction of the tire can be achieved with an indicated enhanced durability from the physical properties reported in Table 4 of Example II.

From Table 5 it can also be seen that the rolling resistances for the Experimental Tires M and N compared favorably with the rolling resistance for the Control Tire L. This is considered herein to be significant in a sense that the inclusion of the internal transition closed cellular layer did not degrade the rolling resistance of the tire.

### EXAMPLE IV

Rubber compositions were prepared for evaluating the effect of the incorporation of short fibers on the properties of the closed cellular rubber compositions. The loading level of the foaming agent was seven phr in the experimental rubber compositions.

Samples 0 through Q are comparative rubber samples containing 0 to 2 phr of polyaramid short fibers in a form of Kevlar™ pulp (contained in 0 to 8.7 phr of Kevlar™ fibers/natural rubber (NR) masterbatch). Samples R through T are experimental rubber samples containing 7 phr of a foaming agent (blowing agent) and 0 through 2 phr of Kevlar™ pulp (contained in 0 to 8.7 phr of Kevlar™ fibers/NR masterbatch). The natural rubber loading (phr) was adjusted in rubber samples P, Q, S and T, based on the quantity of the Kevlar™ fibers/NR masterbatch used in the compound (rubber composition) formulation.

The rubber compositions were prepared by mixing the ingredients in three sequential non-productive (NP) and productive (PR) mixing steps in an internal rubber mixer. The dump temperature for the NP steps was 160° C. The dump temperature for the PR stage was 110° C.

The basic recipe for the rubber samples is presented in the following Table 6 and recited in parts by weight unless otherwise indicated.

TABLE 6

| | Parts |
|---|---|
| Non-Productive Mixing Step (NP1), (mixed to about 160° C.) | |
| Natural rubber | Variable |
| High cis polybutadiene rubber¹ | 30 |
| Carbon black² | 50 |
| Kevlar ™ fibers masterbatch³ | Variable |
| Rubber processing oil | 5 |
| Antioxidant/wax | 5.3 |
| Stearic acid | 2 |
| Zinc Oxide | 2 |
| Non-Productive Mixing Step (NP2), (mixed to about 160° C.) | |
| Carbon black² | 10 |
| Productive Mixing Step (PR), (mixed to about 120° C.) | |
| Sulfur | 1 |
| Benzothiazole sulfenamide and diphenylguanidine accelerators | 2.75 |
| Foaming agent (blowing agent)⁴ | Variable |

¹High cis 1,4-polybutadiene from the Goodyear Tire & Rubber company as BUD1207
²Carbon black N120, an ASTM designation
³Kevlar ™ fibers/NR masterbatch containing 23 percent modified Kevlar ™ polyaramid short fibers from the DuPont Company as Merge IF722, namely 4.35 and 8.70 phr of the masterbatch containing 1 and 2 phr of Kevlar ™ fibers, respectively which is reported in the following Table 7 in terms of the 1 and 2 phr of the Kevlar ™ short fibers (the net Kevlar ™ fibers) contained in the masterbatch.
⁴Foaming agent (blowing agent) as a masterbatch of p,p-Oxybis(benzene) sulfonyl hydrazide (OBSH) and proprietary elastomer (75 percent active) from the AkroChem Company

The following Table 7 illustrates processing characteristics and various physical properties of rubber compositions based upon the basic recipe of Table 6.

TABLE 7

| | Comparative | | | Experimental | | |
|---|---|---|---|---|---|---|
| | O | P | Q | R | S | T |
| Carbon black (phr) | 60 | 60 | 60 | 60 | 60 | 60 |
| Processing oil (phr) | 5 | 5 | 5 | 5 | 5 | 5 |
| Kevlar ™ fibers masterbatch (net) (phr) | 0 | 1 | 2 | 0 | 1 | 2 |
| Foaming agent (phr) | 0 | 0 | 0 | 7 | 7 | 7 |
| Rheometer, 160° C./30 min. | | | | | | |
| Maximum torque (dNm) | 25.8 | 26.3 | 26.4 | 16 | 16.6 | 16.9 |
| Minimum torque (dNm) | 4.2 | 4.3 | 4.6 | 4.1 | 4.4 | 4.6 |
| T90 (minutes) | 3.3 | 3.2 | 3.2 | 4 | 4 | 3.7 |
| Rubber processing analyzer, 100° C.¹ | | | | | | |
| Uncured G′ at 15 percent strain, MPa | 0.29 | 0.29 | 0.30 | 0.27 | 0.31 | 0.32 |
| Shore A Hardness | | | | | | |
| 0° C. | 72 | 74 | 74 | 64 | 67 | 70 |
| 23° C. | 70 | 73 | 72 | 61 | 65 | 66 |
| 100° C. | 66 | 68 | 69 | 55 | 59 | 61 |
| Rebound | | | | | | |
| 0° C., % | 38.4 | 38 | 37.2 | 40.2 | 38.2 | 39.6 |
| 23° C., % | 45.8 | 43.8 | 44 | 46.2 | 44.6 | 46 |
| 100° C., % | 57.2 | 55.8 | 56.2 | 53.2 | 52.2 | 54.4 |
| Stress-strain, ATS, 14 min./ | | | | | | |
| 160° C., Parellel² | | | | | | |
| Tensile strength (MPa) | 24.6 | 24.7 | 24.3 | 16.9 | 17.7 | 17.9 |
| 50% modulus (MPa) | 1.9 | 2.8 | 4.1 | 1.3 | 2.2 | 3.1 |
| 100% modulus (MPa) | 3.4 | 4.6 | 5.7 | 2.2 | 3.3 | 4.3 |
| 300% modulus (MPa) | 16.6 | 17.2 | 18 | 10 | 11.7 | 12.4 |
| Elongation at break, % | 431 | 433 | 408 | 457 | 433 | 421 |
| Stress-strain, ATS, 14 min./160° C., | | | | | | |
| Perpendicular² | | | | | | |
| Tensile strength (MPa) | 23.3 | 21.9 | 21.5 | 17.2 | 16.5 | 15.7 |
| 50% modulus (MPa) | 1.9 | 1.9 | 1.9 | 1.3 | 1.4 | 1.5 |
| 100% modulus (MPa) | 3.2 | 3.2 | 3.2 | 2 | 2.1 | 2.3 |
| 300% modulus (MPa) | 15.2 | 14.8 | 14.8 | 8.9 | 9.1 | 9.5 |
| Elongation at break, % | 433 | 426 | 416 | 507 | 481 | 462 |
| Density at 23° C., g/cm³ | 1.12 | 1.12 | 1.12 | 0.97 | 1.02 | 0.98 |
| Closed cell content at 23° C., percent | 0 | 0 | 0 | 15 | 9 | 14 |

¹Data according to Rubber Process Analyzer as RPA 2000 ™ instrument from Alpha Technologies
²Data according to Automated Testing System instrument by the Instron Corporation which incorporates six tests in one system. Such instrument may determine ultimate tensile, ultimate elongation, moduli, etc.

It can be seen from Table 7 that in comparison with the comparative rubber samples O through Q, experimental rubber samples R through T containing a foaming agent and different loading levels of the Kevlar™ fibers/NR masterbatch exhibited similar processing characteristics as indicated from the similar uncured G′ value from 0.27 to 0.32 MPa. Similarly, the minimum torque of the experimental rubber samples R through T as measured from the rheometer during curing was seen to be more or less in line with that of the comparative rubber samples O through Q. This is considered to be significant in a sense that the processing characteristics of the comparative rubber samples were essentially maintained from the use of foaming agent and from the inclusion of Kevlar™ short fibers in the rubber composition.

It can also be seen from Table 7 that in comparison with the comparative rubber sample O, the inclusion of the Kevlar™ short fibers in comparative rubber sample P and Q led to much increased Shore A hardness. A rubber composition with high Shore A hardness is in general undesirable for ride comfort of tires. The use of a foaming agent in experimental rubber sample R resulted in much reduced Shore A hardness, desirable for enhanced ride comfort of tires. However, as will be described thereafter, the use of foaming agent in the rubber composition alone would also lead to reduced stiffness in the lateral direction, undesirable for steering and handling performance of tires. The combination of the foaming agent and Kevlar™ short fibers gave rise to rubber compositions (Experimental rubber samples S and T) with reduced room temperature Shore A hardness of 65 to 66, desirable for enhanced ride comfort of tires, in comparison with the comparative rubber sample O having much higher room temperature Shore Hardness of 70.

It can also be seen from Table 7 that the rebound value of the experimental rubber samples S and T were either equal or just slightly less favorable than those of the comparative rubber sample O. This is considered to be significant in the sense that the use of the foaming agent and the inclusion of Kevlar™ short fibers into the rubber composition do not significantly affect the rolling resistance and heat build up performance of tires. As will be demonstrated from Example V, the rebound properties of the rubber composition can be enhanced through proper loading of the foaming agent, hence improving the rolling resistance and heat build up performance of the rubber composition.

It can further be seen from Table 7 that the inclusion of Kevlar™ short fibers in the rubber composition led to a significant enhancement in the low-elongation (50 to 100 percent) stiffness parallel to the orientation of the short fiber while the low-elongation (50 to 100 percent) stiffness perpendicular to the orientation of the short fiber was not affected. The use of the foaming agent alone in the rubber composition resulted in much reduced low-elongation (50 to 100 percent) stiffness in both directions, parallel and perpendicular to the orientation of the short fiber. The combination of the foaming agent and the Kevlar™ short fiber, on the other hand, led to rubber compositions with much enhanced low-elongation (50 to 100 percent) stiffness parallel to and lower low-elongation (50 to 100 percent) stiffness perpendicular to the orientation of the short fiber in comparison with the comparative rubber sample O. The orientation of the short fiber was achieved in the laboratory through passing the rubber composition through an open mill with narrow gap between the two rolls. The test was selected to demonstrate the impact of the inclusion as well as the orientation of the short fiber on the stiffness of the rubber composition parallel and perpendicular to the tread surface. The results clearly indicate that the combination of the foaming agent and the short fiber in the rubber composition would give rise to tire components (subtread, for example) with reduced stiffness perpendicular to and enhanced stiffness parallel to the tread surface. This is considered to be significant in the sense that a lower stiffness value perpendicular to the tread surface would lead to enhanced ride comfort with predictive reduced internally generated noise while a higher stiffness value parallel to the tread surface would give rise to enhanced handling performance of tires. The practice of this invention would therefore be expected to achieve both improved ride comfort and enhanced handling performances of tires, performances that are difficult to achieve simultaneously through prior art. Besides, the use of the foamed rubber composition as components of tires would also give rise to reduced noise through the absorption of sound by the microcells in the rubber composition.

As can be seen from Table 7, the use of 7 phr of the foaming agent led to reduced density of the rubber composition, resulting in a void content from 9 to 15 percent.

This example demonstrates the desirability and benefits of the use of both (the combination of) foaming agent and short fiber for improved ride comfort and enhanced handling performance of tires. However, further improvements in rebound and hysteresis loss properties, as will be described in Example V, can be achieved through an increased loading level of the foaming agent, together with a further reduced density of the rubber composition.

### EXAMPLE V

Rubber compositions were prepared for evaluating the effect of the incorporation of short fibers on the properties of the foamed rubber compositions. The loading level of the foaming agent was 8 phr in the experimental rubber samples.

Samples U through W are comparative rubber samples containing 0 to 2 phr of Kevlar™ pulp (0 to 8.7 phr of Kevlar™ fibers/NR masterbatch). Samples X through Z are experimental rubber samples containing 8 phr of a foaming agent and 0 through 2 phr of Kevlar™ pulp (0 to 8.7 phr of Kevlar™ fibers/NR masterbatch). The natural rubber loading (phr) was adjusted in rubber samples V, W, Y and Z, based on the quantity of the Kevlar™ fibers/NR masterbatch used in the compound formulation.

The rubber compositions were prepared by mixing the ingredients in three sequential non-productive (NP) and productive (PR) mixing steps in an internal rubber mixer. The dump temperature for the NP steps was 160° C. The dump temperature for the PR step was 110° C.

The basic recipe for the rubber samples is presented in Table 6 and recited in parts by weight unless otherwise indicated.

The following Table 8 illustrates processing characteristics and various physical properties of rubber compositions based upon the basic recipe of Table 6.

TABLE 8

| | Comparative | | | Experimental | | |
|---|---|---|---|---|---|---|
| | U | V | W | X | Y | Z |
| Carbon black (phr) | 60 | 60 | 60 | 60 | 60 | 60 |
| Processing oil (phr) | 5 | 5 | 5 | 5 | 5 | 5 |
| Kevlar ™ fibers masterbatch (net) (phr) | 0 | 1 | 2 | 0 | 1 | 2 |
| Foaming agent (phr) | 0 | 0 | 0 | 8 | 8 | 8 |
| Rheometer, 160° C./30 min. | | | | | | |
| Maximum torque (dNm) | 25.8 | 26.3 | 26.4 | 15.2 | 15.4 | 16 |
| Minimum torque (dNm) | 4.2 | 4.3 | 4.6 | 4.1 | 4.5 | 4.6 |
| T90 (minutes) | 3.3 | 3.2 | 3.2 | 4 | 4.1 | 3.6 |
| Rubber processing analyzer, 100° C.¹ | | | | | | |
| Uncured G′ at 15% strain, MPa | 0.29 | 0.29 | 0.30 | 0.28 | 0.31 | 0.32 |
| Shore A Hardness | | | | | | |
| 0° C. | 72 | 74 | 74 | 62 | 66 | 67 |
| 23° C. | 70 | 73 | 72 | 60 | 63 | 63 |
| 100° C. | 66 | 68 | 69 | 54 | 57 | 58 |
| Rebound | | | | | | |
| 0° C., % | 38.4 | 38 | 37.2 | 41.6 | 43.6 | 42.0 |
| 23° C., % | 45.8 | 43.8 | 44 | 46.4 | 48.6 | 47.8 |
| 100° C., % | 57.2 | 55.8 | 56.2 | 54.4 | 57 | 56.4 |
| Stress-strain, ATS, 14 min./ | | | | | | |
| 160° C., Parellel² | | | | | | |
| Tensile strength (MPa) | 24.6 | 24.7 | 24.3 | 15.9 | 16.2 | 15.2 |
| 50% modulus (MPa) | 1.9 | 2.8 | 4.1 | 1.3 | 2 | 2.8 |
| 100% modulus (MPa) | 3.4 | 4.6 | 5.7 | 2 | 2.9 | 3.8 |
| 300% modulus (MPa) | 16.6 | 17.2 | 18 | 9.1 | 10 | 11 |
| Elongation at break, % | 431 | 433 | 408 | 470 | 451 | 408 |
| Stress-strain, ATS, 14 min./ | | | | | | |
| 160° C., Perpendicular² | | | | | | |
| Tensile strength (MPa) | 23.3 | 21.9 | 21.5 | 14.3 | 15.3 | 15 |
| 50% modulus (MPa) | 1.9 | 1.9 | 1.9 | 1.2 | 1.3 | 1.4 |
| 100% modulus (MPa) | 3.2 | 3.2 | 3.2 | 1.8 | 2 | 2.1 |
| 300% modulus (MPa) | 15.2 | 14.8 | 14.8 | 8.1 | 8.4 | 8.9 |
| Elongation at break, % | 433 | 426 | 416 | 471 | 479 | 456 |
| Density at 23° C., g/cm³ | 1.12 | 1.12 | 1.12 | 0.91 | 0.91 | 0.92 |
| Closed cell content at 23° C., percent | 0 | 0 | 0 | 23 | 23 | 21 |

It can be seen from Table 8 that in comparison with the comparative rubber samples U through W, experimental rubber samples X through Z containing a foaming agent and different loading levels of the Kevlar™ fibers/NR masterbatch exhibited similar processing characteristics as indicated from the similar uncured G′ value from 0.28 to 0.32 MPa. Similarly, the minimum torque of the experimental rubber samples X through Z as measured from the rheometer during curing was seen to be more or less in line with that of the comparative rubber samples U through W. This is considered to be significant in a sense that the processing characteristics of the comparative rubber samples were essentially maintained from the use of foaming agent and from the inclusion of Kevlar™ short fibers in the rubber composition.

It can also be seen from Table 8 that in comparison with results from Example IV, the use of a higher loading level of the foaming agent in experimental rubber sample X resulted in a further reduction in the Shore A hardness, more desirable for enhanced ride comfort of tires. However, as will be described thereafter, the use of foaming agent in the rubber composition alone would also lead to reduced stiffness in the lateral direction, undesirable for steering and handling performance of tires. The combination of the foaming agent and Kevlar™ short fibers gave rise to rubber compositions (Experimental rubber samples Y and Z) with much reduced room temperature Shore A hardness of 63, desirable for enhanced ride comfort of tires, in comparison with the comparative rubber sample U that exhibits much higher room temperature Shore A hardness of 70.

It can also be seen from Table 8 that the rebound value of the experimental rubber samples Y and Z were either equal to or slightly more favorable, especially the rebound at room temperature, than those of the comparative rubber sample U. This is considered to be significant in the sense that the use of the foaming agent and the inclusion of Kevlar™ short fibers into the rubber composition do not significantly affecting rolling resistance and heat build up performance of tires. As will be demonstrated from Example VI, the rebound of the rubber composition can be further enhanced through proper loading of carbon black, hence improving the rolling resistance and heat build up performance of the rubber composition.

It can further be seen from Table 8 that the inclusion of Kevlar™ short fibers in the rubber composition led to a significant enhancement in the low-elongation (50 to 100 percent) stiffness parallel to the orientation of the short fiber while the low-elongation (50 to 100 percent) stiffness perpendicular to the orientation of the short fiber was not affected. The use of the foaming agent alone in the rubber composition resulted in much reduced low-elongation (50 to 100 percent) stiffness in both directions, parallel and perpendicular to the orientation of the short fiber. The combination of the foaming agent and the Kevlar™ short fiber, on the other hand, led to rubber compositions with much enhanced low-elongation (50 to 100 percent) stiffness parallel to and lower low-elongation (50 to 100 percent) stiffness perpendicular to the orientation of the short fiber in comparison with the comparative rubber sample U. The results clearly indicate that the combination of the foaming agent and the short fiber in the rubber composition would give rise to tire components (subtread, for example) with reduced stiffness perpendicular to and enhanced stiffness parallel to the tread surface. This is considered to be significant in the sense that a lower stiffness value perpendicular to the tread surface would lead to enhanced ride comfort while a higher stiffness value parallel to the tread surface would give rise to enhanced handling performance of tires. The practice of this invention would therefore be expected to achieve both improved ride comfort and enhanced handling performances of tires, performances that are difficult to achieve simultaneously through prior art. Besides, the use of the foamed rubber composition as components of tire would also give rise to reduced noise through the absorption of sound by the microcells in the rubber composition.

As can be seen from Table 8, in comparison with results from Example IV, the use of 8 phr of the foaming agent led to further reduced density of the tuber composition, resulting in a void content from 21 to 23 percent.

This example demonstrates the desirability and benefits of the use of both foaming agent and short fiber for improving ride comfort and enhancing handling performance of tires without significantly affecting the rolling resistance performance of tires. Further improvements in rebound, as will be described in Example VI, can be achieved through the use of the foaming agent and reduced filler loading.

### EXAMPLE VI

Rubber compositions were prepared for evaluating the effect of the incorporation of short fibers on the properties of the foamed rubber compositions. The loading level of the foaming agent was 7 phr in the experimental work. This example differs from Examples IV and V in the sense that the filler loading level was substantially reduced to further enhance the rebound and the hysteresis properties of the rubber composition.

Sample AA is a comparative rubber sample containing 70 phr of carbon black and 35 phr of processing oil and hence considered to be a representative tread rubber composition. Samples BB and CC are comparative rubber samples containing 0 to 2 phr of Kevlar™ pulp (0 to 8.7 phr of Kevlar™ fiber/NR masterbatch). Samples DD and EE are experimental rubber samples containing 7 phr of a foaming agent and 0 through 2 phr of Kevlar™ pulp (0 to 8.7 phr of Kevlar™ fiber/NR masterbatch). The natural rubber loading (phr) was adjusted in rubber samples containing the Kevlar™ fiber masterbatch, based on the quantity of the Kevlar™ fiber/NR masterbatch used in the compound formulation.

The rubber compositions were prepared by mixing the ingredients in three sequential non-productive (NP1 and NP2) and productive (PR) mixing steps in an internal rubber mixer. The dump temperature for the NP steps was 160° C. The dump temperature for PR was 110° C.

The basic recipe for the rubber samples is presented in the following Table 9 and recited in parts by weight unless otherwise indicated.

TABLE 9

| | AA | BB, CC, DD, EE |
|---|---|---|
| Non-Productive Mixing Step (NP1), | | |
| (mixed to about 160° C.) | | |
| E-SBR | 70 | 0 |
| Natural rubber | 0 | Variable |
| High cis polybutadiene rubber¹ | 30 | 30 |
| Carbon Black² | 70 | 45 |
| Kevlar ™ fiber masterbatch³ | 0 | Variable |
| Rubber processing oil | 35 | 5 |
| Antioxidant/wax | 5.0 | 5.3 |
| Stearic acid | 2 | 2 |
| Zinc Oxide | 1.8 | 2 |
| Productive Mixing Step (PR), | | |
| (mixed to about 110° C.) | | |
| Sulfur | 1.5 | 1 |
| Benzothiazole sulfenamide based accelerator | 1.5 | 2.5 |
| Diphenylguanidine based accelerator | 0.25 | 0.25 |
| Foaming agent⁴ | 0 | Variable |

The following Table 10 illustrates processing characteristics and various physical properties of rubber compositions based upon the basic recipe of Table 9.

TABLE 10

| | Comparative | | | Experimental | |
|---|---|---|---|---|---|
| | AA | BB | CC | DD | EE |
| Carbon black (phr) | 70 | 45 | 45 | 45 | 45 |
| Processing oil (phr) | 35 | 5 | 5 | 5 | 5 |
| Kevlar ™ fiber masterbatch (net) (phr) | 0 | 0 | 2 | 0 | 2 |
| Foaming agent (phr) | 0 | 0 | 0 | 7 | 7 |
| Rheometer, 160° C./30 min. | | | | | |
| Maximum torque (dNm) | 23.8 | 19.2 | 19.2 | 11.2 | 11.7 |
| Minimum torque (dNm) | 3.5 | 3 | 2.9 | 2.8 | 3.2 |
| T90 (minutes) | 11.32 | 3.8 | 3.9 | 5.3 | 4.6 |
| Rubber processing analyzer, 100° C.¹ | | | | | |
| Uncured G′ at 15% strain, MPa | 0.25 | 0.22 | 0.24 | 0.22 | 0.26 |
| Shore A Hardness | | | | | |
| 0° C. | 72 | 59 | 63 | 50 | 5 |
| 23° C. | 66 | 60 | 66 | 48 | 53 |
| 100° C. | 57 | 59 | 63 | 44 | 50 |
| Rebound | | | | | |
| 0° C., % | 17.4 | 48 | 46.6 | 43.9 | 44.5 |
| 23° C., % | 28.0 | 56.3 | 56.5 | 52.1 | 53 |
| 100° C., % | 51.4 | 69.5 | 69 | 58.1 | 58.8 |
| Stress-strain, ATS, 14 min./ | | | | | |
| 160° C., Parellel² | | | | | |
| Tensile strength (MPa) | 20.3 | 25.4 | 24 | 17.9 | 15.5 |
| 50% modulus (MPa) | 1.1 | 1.3 | 2.8 | 1.1 | 2.4 |
| 100% modulus (MPa) | 1.7 | 2.1 | 4.1 | 1.5 | 3.3 |
| 300% modulus (MPa) | 11.0 | 11.1 | 12.7 | 5.9 | 8.7 |
| Elongation at break, % | 580 | 517 | 473 | 586 | 465 |
| Stress-strain, ATS, 14 min./ | | | | | |
| 160° C., Perpendicular² | | | | | |
| Tensile strength (MPa) | 20.5 | 15.8 | 21.5 | 15.2 | 15.9 |
| 50% modulus (MPa) | 1.1 | 1.2 | 1.4 | 1.4 | 1.5 |
| 100% modulus (MPa) | 1.5 | 2.0 | 2.2 | 1.4 | 1.5 |
| 300% modulus (MPa) | 10.5 | 11.0 | 10.1 | 5.8 | 5.8 |
| Elongation at break, % | 638 | 383 | 490 | 529 | 558 |
| Density at 23° C.,_g/cm³ | 1.12 | 1.08 | 1.08 | 0.94 | 0.95 |
| Closed cell content at 23° C., percent | 0 | 0 | 0 | 16 | 14 |

It can be seen from Table 10 that in comparison with the comparative rubber samples AA, BB and CC, experimental rubber samples DD and EE containing a foaming agent and the Kevlar™ fiber/NR masterbatch exhibited similar processing characteristics as indicated from the similar uncured G′ value from 0.22 to 0.26 MPa. Similarly, the minimum torque of the experimental rubber samples DD and EE as measured from the rheometer during curing was seen to be more or less in line with that of the comparative rubber samples AA, BB and CC. This is considered to be significant in a sense that the processing characteristics of the comparative rubber samples were essentially maintained from the use of foaming agent and from the inclusion of Kevlar™ short fibers in the rubber composition.

It can also be seen from Table 10 that in comparison with the comparative rubber sample AA the use of low loading of filler in combination with the blow agent in experimental rubber sample DD resulted in much reduced Shore A hardness of 48, desirable for enhanced ride comfort of tires. However, as was described previously, the use of foaming agent in the rubber composition alone would also lead to reduced stiffness in the lateral direction, undesirable for steering and handling performance of tires. The combination of the foaming agent and Kevlar™ short fibers gave rise to rubber compositions (Experimental rubber sample EE) with much reduced room temperature Shore A hardness of 53, desirable for enhanced ride comfort of tires, in comparison with the comparative rubber sample AA that exhibits much higher room temperature Shore A hardness of 66.

It can also be seen from Table 10 that the rebound values at different temperatures of the experimental rubber sample EE were much more favorable than those of the comparative rubber sample AA. This is considered to be significant in the sense that the use of the foaming agent and the inclusion of Kevlar™ short fibers into the rubber composition with reduced filler loading would result in improved rolling resistance and heat build up performance of tires.

It can further be seen from Table 10 that the use of the foaming agent alone in the rubber composition resulted in much reduced low-elongation (50 to 100 percent) stiffness in both directions, parallel and perpendicular to the orientation of the short fiber. The combination of the foaming agent and the Kevlar™ short fiber, on the other hand, led to rubber compositions with much enhanced low-elongation (50 to 100 percent) stiffness parallel to and lower low-elongation (50 to 100 percent) stiffness perpendicular to the orientation of the short fiber in comparison with the comparative rubber sample AA. The results clearly indicate that the combination of the foaming agent and the short fiber in the rubber composition would give rise to tire components (subtread, for example) with similar stiffness perpendicular to and enhanced stiffness parallel to the tread surface. This is considered to be significant in the sense that a lower stiffness value perpendicular to the tread surface would lead to enhanced ride comfort while a higher stiffness value parallel to the tread surface would give rise to enhanced handling performance of tires. The practice of this invention would therefore be expected to achieve both improved ride comfort and enhanced handling performances of tires, performances that are difficult to achieve simultaneously through prior art. Besides, the use of the foamed rubber composition as components of tire would also give rise to reduced noise through the absorption of sound by the microcells in the rubber composition.

As can be seen from Table 10, in comparison with rubber samples DD and EE, the use of 7 phr of the foaming agent led to reduced density of the tuber composition, resulting in a void content from 14 to 16 percent.

### EXAMPLE VII

Vehicular tires were prepared as a build-up assembly of uncured rubber components including a tread having layered configuration.

For a Control Tire FF, the tread configuration comprised of an outer tread cap rubber layer and an internal, intermediate tread layer (the same Comparative rubber sample AA from Example VI for both layers) and a tread base rubber layer.

Two Experimental rubber tires GG and HH were similarly prepared except that the tread was divided into a tread cap and an internal, intermediate tread layer and a tread base rubber layer. The intermediate tread layer was provided as rubber compositions according to the formulations of rubber samples DD and EE, respectively, of Example VI. The cap rubber layer was about 60 percent and the intermediate tread layer was about 40 percent of the total tread gauge excluding the tread base rubber layer.

The tire assemblies were individually placed in a suitable tire mold under conditions of elevated pressure and temperature to shape and cure the respective tires.

For Experimental Tires GG and HH the blowing agent contained in the internal transition rubber layer was caused by the elevated molding temperature to liberate its gas to form the closed cellular structure, or configuration, in situ within the internal rubber layer of the tire tread within the tire mold, and to therefore form a tire with a tread cross-section similar to FIG. 1 of the Drawings.

The following Table 11 reports observed results.

TABLE 11

| | Tire | | |
|---|---|---|---|
| | Control | Experimental | |
| | FF | GG | HH |
| Outer non-cellular tread cap layer | AA | AA | AA |
| composition | | | |
| Internal tread rubber layer composition | AA | DD | EE |
| Tread base rubber layer | Natural rubber (NR) | | |
| | based rubber | | |
| | composition for | | |
| | all three tires | | |
| Tire weight | | | |
| Weight (kg) | 10.51 | 10.18 | 10.15 |
| Ranking, normalized to 100 for the Control | 100 | 103 | 104 |
| Tire rolling resistance performance⁽³⁾ | | | |
| Rolling resistance (kg/ton) | 10.15 | 8.95 | 9.33 |
| Rolling resistance ranking | 100 | 113 | 109 |
| (normalized to 100) | | | |
| Tire noise performance⁽⁴⁾ | | | |
| Noise (dB) | 100.9 | 94.1 | 96.5 |
| Noise ranking (normalized to 100) | 100 | 107 | 104 |
| Tire handling performance⁽⁵⁾ | | | |
| Handling rating | 5.9 | 5.7 | 5.9 |
| Handling ranking (normalized to 100) | 100 | 96 | 100 |

³Rolling resistance normalized to a comparative value of 100 for the Control
⁴Tests were performed on a smooth surface simulating asphalt payment while rolling at 96 km per hour. The microphone was 1 m to the side of the tire and noise was overall sound pressure level in frequencies ranging from 0 to 2000 Hz.
⁵Tire handling normalized to a comparative value of 100 for the Control

From Table 11 it can be seen that the overall weights of the Experimental Tires GG and HH, which contained the internal intermediate closed cellular rubber, are significantly reduced as compared to the Control Tire FF.

This is considered herein as being significant in a sense that a weight reduction of tires can beneficially affect the rolling resistance performance of tires.

From Table 11 it can also be seen that the rolling resistances for the Experimental Tires GG and HH compared favorably with the rolling resistance for the Control Tire FF. This is considered herein to be significant in a sense that the inclusion of the internal transition closed cellular layer improved the rolling resistance of the tire.

From Table 11 it can further be seen that using the foam (closed cellular rubber) intermediate layer, with or without short fiber reinforcement, led to tires with much reduced noise. This is considered herein to be significant in a sense that the inclusion of the internal transition closed cellular layer would enhance the driving pleasure of the consumer.

However, as can be seen from Table 11, the use of the foam (closed cellular rubber) intermediate layer without short fiber reinforcement had a negative impact on the handling performance of tires, probably due to much reduced lateral stiffness in the foam intermediate layer. In contrast, the use of an intermediate layer with a combination of closed cellular structure and reinforcement in a form of short fibers led to tires with equivalent handling performance as the Control Tire FF.

This is considered herein to be significant in a sense that the enhancement of noise performance of tires through the inclusion of the internal transition closed cellular layer containing short fibers is not at the expense of degrading the handling performances of tires.

This example demonstrates the desirability and benefits of the use of both foaming agent and short fiber for simultaneously improving ride comfort and enhancing handling performance of tires together with improved rolling resistance performance of tires.

It is considered herein these Examples show that a pneumatic tire with the intermediate transition closed cellular rubber layer can be particularly beneficial for such closed cellular rubber intermediate transition layer where the rubber composition is comprised of natural cis 1,4-polyisoprene rubber and cis 1,4-polybutadiene rubber, rubber reinforcing carbon black, the polyaramid fiber and blowing agent, particularly where it is formed with the blowing agent comprised of a masterbatch of p,p-Oxybis(benzene) sulfonyl hydrazide (OBSH) and proprietary elastomer (75 percent active) from the AkroChem Company.

Such cellular rubber layer may therefore be comprised of:

(A) 100 phr of elastomers comprised of:
(1) natural cis 1,4-polyisoprene rubber in an amount of from about 60 to about 80 phr, and
(2) cis 1,4-polybutadiene rubber in an amount of from about 20 to about 40 phr,

(B) rubber reinforcing carbon black in a range of from about 35 to about 60 phr,

(C) the polyaramid (Kevlar™) short fibers in an amount of from about 1 to about 3, more desirably from about 1 to about 2, phr, and

(D) where the blowing agent masterbatch (75 percent active) is used in amount of from about 5 to about 9 phr.

While certain representative embodiments and details have been shown for the purpose of illustrating the subject invention, it will be apparent to those skilled in this art that various changes and modifications can be made therein without departing from the scope of the subject invention.

What is claimed is:

1. A tire having a rubber tread comprised of a circumferential non-cellular tread outer cap layer and an internal circumferential intermediate transition closed cellular rubber layer positioned between said outer tread cap rubber layer and a tread base non-cellular rubber layer;
wherein said outer tread cap rubber layer is comprised of a lug and groove configuration with raised lugs having tread running surfaces on the outer surfaces of said lugs (said running surfaces intended to be ground-contacting) and grooves positioned between said lugs,
wherein said internal intermediate transition cellular rubber layer is excluded from the running surface of the tire, and
wherein said internal intermediate transition cellular rubber layer thereby abridges and joins said outer non-cellular rubber cap layer and said non-cellular base rubber layer of said tread configuration.

2. The tire of claim 1 wherein said internal closed cellular rubber transition rubber layer is comprised of an in situ formed closed cellular structure which is formed during the curing of the tire assembly at an elevated temperature by activation of an elevated temperature activatable blowing agent.

3. The tire of claim 1 wherein the rubber composition of said internal closed cellular rubber layer contains the product of a combination of a methylene donor and methylene acceptor.

4. The tire of claim 3 whether said product of methylene donor and methylene acceptor is formed by reaction of said methylene donor and methylene acceptor in situ within said rubber composition.

5. The tire of claim 4 wherein said methylene donor is comprised of at least one of hexamethoxymethylmelamine, hexaethoxymethylmelamine, ethoxymethylpyridinium chloride, N,N′,N′-trimethylmelamine, N-methylmelamine and N′,N″-methylmelamine, hexamethylenetetramine and their mixtures.

6. The tire of claim 4 wherein said methylene donor is comprised of hexamethoxymethylmelamine.

7. The tire of claim 4 wherein said methylene acceptor is comprised of at least one of phenolformaldehyde reactive resin, resorcinol, resorcinol monobenazoate, phenolic cashew nut oil resin and polyhydric phenoxy resin.

8. The tire of claim 5 wherein said methylene acceptor is comprised of at least one of phenolformaldehyde reactive resin, resorcinol, resorcinol monobenazoate, phenolic cashew nut oil resin and polyhydric phenoxy resin.

9. The tire of claim 1 wherein the rubber composition of said internal closed cellular rubber layer contains one or more of ultra high molecular weight polyethylene (UHMWPE), syndiotactic polybutadiene, short fibers and their mixtures.

10. The tire of claim 1 wherein said internal closed cell transition layer rubber is comprised of, based upon parts by weight per 100 parts by weight rubber (phr):
(A) 100 phr of at least one diene-based elastomer;
(B) about 20 to about 120 phr of reinforcing filler comprised of:
(1) rubber reinforcing carbon black, or
(2) a combination of rubber reinforcing black and synthetic amorphous silica containing up to 100 phr of synthetic amorphous silica.

11. The tire of claim 10 wherein said reinforcing filler is rubber reinforcing carbon black.

12. The tire of claim 10 wherein said reinforcing filler is comprised of rubber reinforcing carbon black and up to 100 phr of amorphous silica wherein said amorphous silica is precipitated silica.

13. The tire of claim 10 wherein said reinforcing filler is comprised of rubber reinforcing carbon black and from about 5 to about 100 phr of amorphous silica wherein said amorphous silica is precipitated silica.

14. The tire of claim 10 wherein said rubber composition further contains one or more of ultra high molecular weight polyethylene (UHMWPE), syndiotactic polybutadiene, and short fibers

15. A process of preparing a tire which comprises the steps of preparing a tire with a tread which contains an internal closed cellular rubber layer positioned between and abridging an outer non-cellular tread rubber layer having a tread running surface and a non-cellular tread base rubber layer which comprises the steps of:
(A) preparing an uncured rubber layer comprised of a rubber composition which contains an elevated temperature activatable blowing agent,
(B) building an uncured rubber tire assembly which includes a circumferential tread comprised of an outer uncured rubber layer without an elevated temperature activatable blowing agent and a circumferential internal uncured rubber layer which contains an elevated temperature activatable blowing agent wherein said internal uncured rubber layer is positioned between and abridges said outer uncured rubber layer and a circumferential uncured tread base rubber layer which does not contain an elevated temperature blowing agent,
(C) placing said uncured rubber tire assembly in a tire mold under conditions of elevated pressure and temperature to mold and cure the rubber tire assembly, including said tread,
wherein said elevated temperature activatable blowing agent is thereby activated to release a gaseous byproduct in situ within the rubber composition and form a closed cellular structure for said internal rubber layer within said tread during the curing of said internal rubber layer.

16. The process of claim 15 wherein said circumferential uncured rubber tread is prepared by co-extruding together said uncured internal rubber layer, outer uncured layer and uncured tread base rubber layer to from an uncured tread rubber strip.

17. The process of claim 15 wherein said blowing agent is comprised of at least one of p,p′-oxybis(benzenesulfonyl hydrazide), dinitrosopentamethylene tetramine, N,N′-dimethyl-N,N′-ditnitrosophthalimide, azodicarbonamide, sulfonyl hydrazides such as for example, benzenesulfonyl hydrazide, toluenesulfonyl hydrazide, p-toluene sulfonyl semicarbazide and p,p′-oxy-bis-(benzenesulfonyl semicarbazide).

18. The tire of claim 1 wherein the cellular rubber contains short fibers and wherein said short fibers are polyaramid fibers

19. The tire of claim 1 wherein said cellular rubber is comprised of natural cis 1,4-polyisoprene rubber and cis 1,4-polybutadiene rubber; rubber reinforcing carbon black, and polyaramid short fibers.

20. The tire of claim 1 wherein said cellular rubber is comprised of:
(A) 100 phr of elastomers comprised of:
(1) cis 1,4-polyisoprene natural rubber in an amount of from about 60 to about 80 phr, and
(2) cis 1,4-polybutadiene rubber in an amount of from about 20 to about 40 phr,
(B) rubber reinforcing carbon black in a range of from about 35 to about 60 phr,
(C) polyaramid short fibers in an amount of from about 1 to about 3 phr, and
(D) where a blowing agent to form said closed cellular rubber is from about 5 to about 9 phr as a masterbatch of p,p-Oxybis(benzene) sulfonyl hydrazide (OBSH) and elastomer (75 percent active).
